(19) United States
(12) Patent Application Publication
(10) Pub. No.: US 2005/0206648 A1
(43) Pub. Date: Sep. 22, 2005

(54) Pipeline and cache for processing data progressively

(76) Inventors: Ronald N. Perry, Cambridge, MA (US); Sarah F. Frisken, Cambridge, MA (US)

Correspondence Address: Patent Department;Mitsubishi Electric Research Laboratories, Inc., 201 Broadway, Cambridge, MA, 02139, US

(21) Appl. No.: 10/802,468

(22) Filed: Mar. 16, 2004

(51) Int. Cl. G09G 5/36; G06T 1/20

(52) U.S. Cl. 345/557; 345/506

(57) ABSTRACT

A system for processing data includes a processing pipeline, a progressive cache, and a cache manager. The progressive cache includes stages connected serially to each other so that an output element of a previous stage is sent as an input element to a next stage. A first stage is configured to receive input for a processing request. A last stage is configured to produce output corresponding to the input. The progressive cache includes caches arranged in an order from least finished cache elements to most finished cache elements. Each cache of the progressive cache receives an output cache element of a corresponding stage of the processing pipeline and sends an input cache element to a next stage after the corresponding stage. The cache controller routes cache elements from the processing pipeline to the progressive cache in the order from a least finished cache element to a most finished cache element and from the progressive cache to the processing pipeline in the order from the most finished cache element to the next stage after the corresponding stage.

### FIELD OF INVENTION

The invention relates generally to computer architectures, and more particularly to processing pipelines and caches.

### BACKGROUND

As shown in FIG. 1, processing pipelines are well known. A processing pipeline 100 includes stages 111-115 connected serially to each other. A first stage receives input 101, and a last stage 115 produces output 109. Generally, the output data of each stage is sent as input data to a next stage. The stages can concurrently process data. For example, as soon as one stage completes processing its data, the stage can begin processing next data received from the previous stage. As an advantage, pipelined processing increases throughput, since different portions of data can be processed in parallel.

As shown in FIG. 2, caches 200 are also well known. When multiple caches 211-215 are used, they are generally arranged in a hierarchy. The cache 215 ‘closest’ to a processing unit 210 is usually the smallest in size and the fastest in access speed, while the cache 211 ‘farthest’ from the processing unit is the largest and the slowest. For example, the cache 215 can be an ‘on-chip’ instruction cache, and the cache 211 a disk storage unit. As an advantage, most frequently used data are readily available to the processing unit.

It is also known how to combine pipelines and caches.

U.S. Pat. No. 6,453,390, Aoki, et al., Sep. 17, 2002, “Processor cycle time independent pipeline cache and method for pipelining data from a cache,” describes a processor cycle time independent pipeline cache and a method for pipelining data from a cache to provide a processor with operand data and instructions without introducing additional latency for synchronization when processor frequency is lowered or when a reload port provides a value a cycle earlier than a read access from the cache storage. The cache incorporates a persistent data bus that synchronizes the stored data access with the pipeline. The cache can also utilize bypass mode data available from a cache input from the lower level when data is being written to the cache.

U.S. Pat. No. 6,427,189, Mulla, et al., Jul. 30, 2002, “Multiple issue algorithm with over subscription avoidance feature to get high bandwidth through cache pipeline,” describes a multi-level cache structure and associated method of operating the cache structure. The cache structure uses a queue for holding address information for memory access requests as entries. The queue includes issuing logic for determining which entries should be issued. The issuing logic further includes first logic for determining which entries meet a predetermined criteria and selecting a plurality of those entries as issuing entries. The issuing logic also includes last logic that delays the issuing of a selected entry for a predetermined time period based upon a delay criteria.

U.S. Pat. No. 5,717,896, Yung, et al., Feb. 10, 1998, “Method and apparatus for performing pipeline store instructions using a single cache access pipestage,” describes a mechanism for implementing a store instruction so that a single cache access stage is required. Since a load instruction requires a single cache access stage, in which a cache read occurs, both the store and load instructions utilize a uniform number of cache access stages. The store instruction is implemented in a pipeline microprocessor such that during the pipeline stages of a given store instruction, the cache memory is read and there is an immediate determination if there is a tag hit for the store. Assuming there is a cache hit, the cache write associated with the given store instruction is implemented during the same pipeline stage as the cache access stage of a subsequent instruction that does not write to the cache or if there is no instruction. For example, a cache data write occurs for the given store simultaneously with the cache tag read of a subsequent store instruction.

U.S. Pat. No. 5,875,468, Erlichson, et al., Feb. 23, 1999, “Method to pipeline write misses in shared cache multiprocessor systems,” describes a computer system with a number of nodes. Each node has a number of processors which share a single cache. A method provides a release consistent memory coherency. Initially, a write stream is divided into separate intervals or epochs at each cache, delineated by processor synch operations. When a write miss is detected, a counter corresponding to the current epoch is incremented. When the write miss globally completes, the same epoch counter is decremented. Synch operations issued to the cache stall the issuing processor until all epochs up to and including the epoch that the synch ended have no misses outstanding. Write cache misses complete from the standpoint of the cache when ownership and data are present.

U.S. Pat. No. 5,283,890, Petolino, Jr., et al., Feb. 1, 1994, “Cache memory arrangement with write buffer pipeline providing for concurrent cache determinations,” describes a cache memory that is arranged using write buffering circuitry. This cache memory arrangement includes a Random Access Memory (RAM) array for memory storage operated under the control of a control circuit which receives input signals representing address information, write control signals, and write cancel signals.

### SUMMARY OF INVENTION

A system for processing data includes a processing pipeline, a progressive cache, and a cache manager.

The processing pipeline includes stages connected serially to each other so that an output element of a previous stage is sent as an input element to a next stage.

A first stage is configured to receive a processing request for input. A last stage is configured to produce output corresponding to the input.

The progressive cache includes caches arranged in an order from least finished cache elements to most finished cache elements. Each cache of the progressive cache receives an output cache element of a corresponding stage of the processing pipeline and sends an input cache element to a next stage after the corresponding stage.

The cache controller routes cache elements from the processing pipeline to the progressive cache in the order from a least finished cache element to a most finished cache element and from the progressive cache to the processing pipeline in the order from the most finished cache element to the next stage after the corresponding stage.

### BRIEF DESCRIPTION OF THE DRAWINGS

FIG. 1 is a block diagram of a prior art processing pipeline;

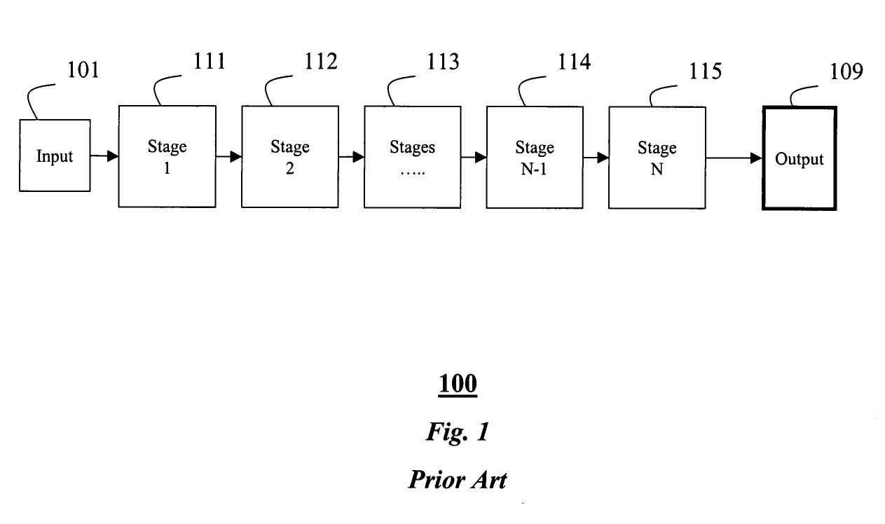

FIG. 2 is a block diagram of a prior art hierarchical cache; and

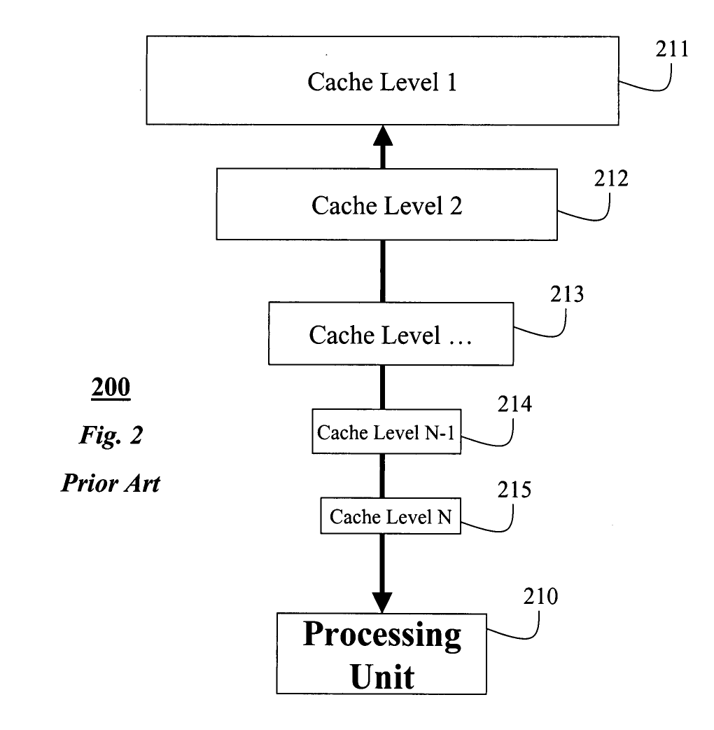

FIG. 3 is a block diagram of a pipeline with a progressive cache according to the invention.

### DETAILED DESCRIPTION OF A PREFERRED EMBODIMENT OF THE INVENTION

System Structure

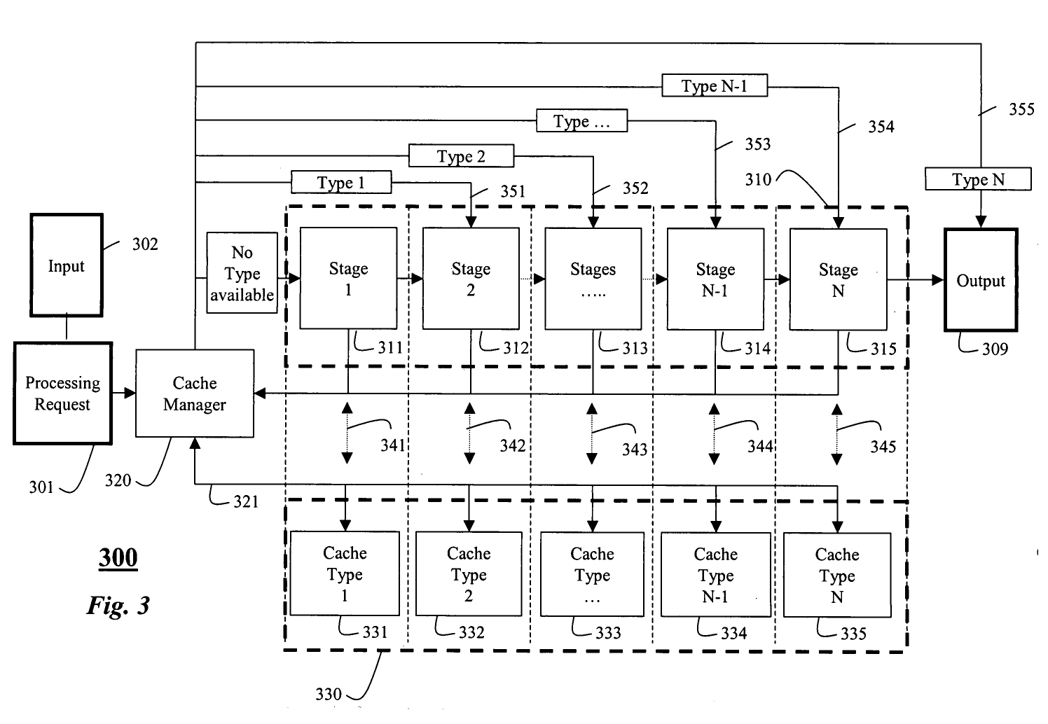

FIG. 3 shows a system 300 for efficiently processing data. The system 300 includes a processing pipeline 310, a cache manager 320, and a progressive cache 330.

The pipeline 310 includes processing stages 311-315 connected serially to each other. The first stage 311 receives input 302 for a processing request 301. The last stage 315 produces output 309. Each stage can provide output for the next stage, as well as to the cache manager 320.

The cache manager 320 connects the pipeline 310 to the progressive cache 330. The cache manager routes cache elements between the pipeline and the progressive cache.

The progressive cache 330 includes caches 331-335. There is one cache for each corresponding stage of the pipeline. The progressive caches 331-335 are arranged, left-to-right in the FIG. 3, from a least finished, i.e., least complete, cache element to a most finished, i.e., most complete, cache element, hence, the cache 330 is deemed to be ‘progressive’. Each cache 331-335 includes data for input to a next stage of a corresponding stage in the pipeline 310 and for output from the corresponding stage.

The one-to-one correspondences between the processing stages of the pipeline and the caches of the progressive cache are indicated generally by the dashed double arrows 341-345.

The stages increase a level of completion of elements passing through the pipeline, and there is a cache for each level of completion. For the purpose of this description, the caches are labeled types 1-5.

System Operation

First, the processing request 301 for the input 302 is received.

Second, the progressive cache 330 is queried 321 by the cache manager 320 to determine a most complete cached element representing the output 309, e.g., cached elements contained in caches 351-355 of cache type 1-5, which is available to satisfy the processing request 301.

Third, a result of querying the progressive cache 330, i.e., the most complete cached element, is sent, i.e., piped, to the appropriate processing stage, i.e., the next stage of the corresponding stage of the pipeline 310, to complete the processing of the data. This means that processing stages can be by-passed. If no cache element is available, then processing of the processing request commences in stage 311. If the most completed element corresponds to the last stage, then no processing needs to be done at all.

After each stage completes processing, the output of the stage can also be sent, i.e., piped, back to the progressive cache 330, via the cache manger 320, for potential caching and later reuse.

As caches fill, least recently used (LRU) cache elements can be discarded. Cache elements can be accessed by hashing techniques.

In another embodiment of the system 300, there are fewer caches in the progressive cache 330 than there are stages in the processing pipeline 310. In this embodiment, not all stages have a corresponding cache. It is sometimes advantageous to eliminate an individual cache in the progressive cache 330 because the corresponding stage is extremely efficient and caching the output in the individual cache would be unnecessary and would waste memory. Furthermore, the output of the corresponding stage may require too much memory to be practical.

One skilled in the art would readily understand how to adapt the system 300 to include various processing pipelines and various progressive caches to enable a processing request to be satisfied.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A system for processing data, comprising:
a processing pipeline including a plurality of stages connected serially to each other so that an output element of a previous stage is sent as an input element to a next stage, and a first stage is configured to receive input for a processing request, and a last stage is configured to produce output corresponding to the input;
a progressive cache including a plurality of caches arranged in an order from least finished cache elements to most finished cache elements, each cache for receiving an output cache element of a corresponding stage and for sending an input cache element to a next stage after the corresponding stage; and
a cache controller configured to route cache elements from the processing pipeline to the progressive cache in the order from a least finished cache element to a most finished cache element and from the progressive cache to the processing pipeline in the order from the most finished cache element to the next stage after the corresponding stage.

2. The system of claim 1, in which the progressive cache includes a cache for each stage of the processing pipeline.

3. The system of claim 1, in which the output cache element is stored in the corresponding cache.

4. The system of claim 1, further comprising:
means for compressing the cache elements.

5. The system of claim 1, in which the cache elements are accessed by hashing.

6. The system of claim 1, in which least recently used cached elements are discarded when the progressive cache is full.

7. The system of claim 1, in which the input is a graphics object, and the output is an image.

8. A method for processing data, comprising:
receiving a processing request, the processing request describing input to be processed;
querying a progressive cache to determine a cached element most representing an output satisfying the processing request;
sending the cached element to a starting stage of a processing pipeline, the starting stage associated with the cached element; and
sending an output of the starting stage as input to a next stage of the processing pipeline, a final stage of the processing pipeline determining the output satisfying the processing request.

9. The method of claim 8 wherein an output of a particular stage of the pipeline is sent to the progressive cache.

10. The method of claim 8 wherein the cache elements are compressed.

11. The method of claim 8 wherein the progressive cache finds the cache elements using hashing.

12. The method of claim 8 wherein the progressive cache eliminates least recently used cached elements from a particular cache in the set of caches when the particular cache is full.

13. The method of claim 8 wherein the starting stage associated with the cached element is a next stage of a corresponding stage of a cache of the progressive cache containing the cached element.

14. An apparatus for processing data, comprising:
means for querying a progressive cache to determine a cached element most representing an output satisfying a processing request for input data;
means for sending the cached element to a starting stage of a processing pipeline for the data, the starting stage associated with the cached element; and
means for sending an output of the starting stage to an input of a next stage of the processing pipeline, a final stage of the processing pipeline determining the output satisfying the processing request for the input data.
